(19) United States
(12) Patent Application Publication
(10) Pub. No.: US 2006/0208103 A1
(43) Pub. Date: Sep. 21, 2006

(54) Floating handheld sprayer

(75) Inventors: Jeffrey A. DeBoer, Ann Arbor, MI (US); Aaron Hughes, San Francisco, CA (US)

Correspondence Address: CARLSON, GASKEY & OLDS, P.C., 400 WEST MAPLE ROAD, SUITE 350, BIRMINGHAM, MI, 48009, US

(73) Assignee: Alsons Corporation

(21) Appl. No.: 11/080,231

(22) Filed: Mar. 15, 2005

(51) Int. Cl. B05B 15/00; E03B 9/20; B05B 9/01

(52) U.S. Cl. 239/289; 239/16; 239/525

(57) ABSTRACT

A handheld sprayer system includes a spray nozzle side having a spray nozzle opposite a sprayer back side having a recessed area to receive hygiene tools. The spray head includes a buoyancy volume which permits the handheld shower sprayer system to float.

### BACKGROUND OF THE INVENTION

The present invention relates to a handheld sprayer, and more particularly to a floating handheld shower sprayer.

A wide variety of handheld sprayer systems are available including handheld shower sprayers in many different configurations. Many factors enter into the comfort, safety, convenience, and ease of use of handheld sprayers including the design and placement of controls and the storage systems to which the handheld shower is stowed. Conventional handheld sprayers are typically attached to a wall unit within which the unit is stowed. Other conventional handheld sprayers are attachable to a faucet such that the handheld sprayer is removable. Other handheld sprayers are retractable into an opening or retractable into an opening adjacent to a sink or bath.

Accordingly, it is desirable to provide a handheld sprayer which provides a variety of features and is not limited to conventional mounting and stowage locations.

### SUMMARY OF THE INVENTION

A handheld sprayer system according to the present invention includes a spray nozzle side opposite a sprayer back side that includes a recessed area to receive hygiene tools such as a sponge, soap, razor or the like. The spray head includes a buoyancy volume which permits the handheld shower sprayer system to float. In a tub environment, operation of the spray nozzle generates a water jet effect within the water. That is, the spray head randomly floats around in the tub agitating the otherwise still water.

The present invention therefore provides a handheld sprayer which provides a variety of features and is not limited to conventional mounting and stowage locations.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view of a handheld sprayer designed according to the present invention;

FIG. 2 is a side view of a handheld sprayer; and

FIG. 3 is a rear view of another handheld sprayer system according to the present invention.

### DETAILED DESCRIPTION OF THE PREFERRED EMBODIMENT

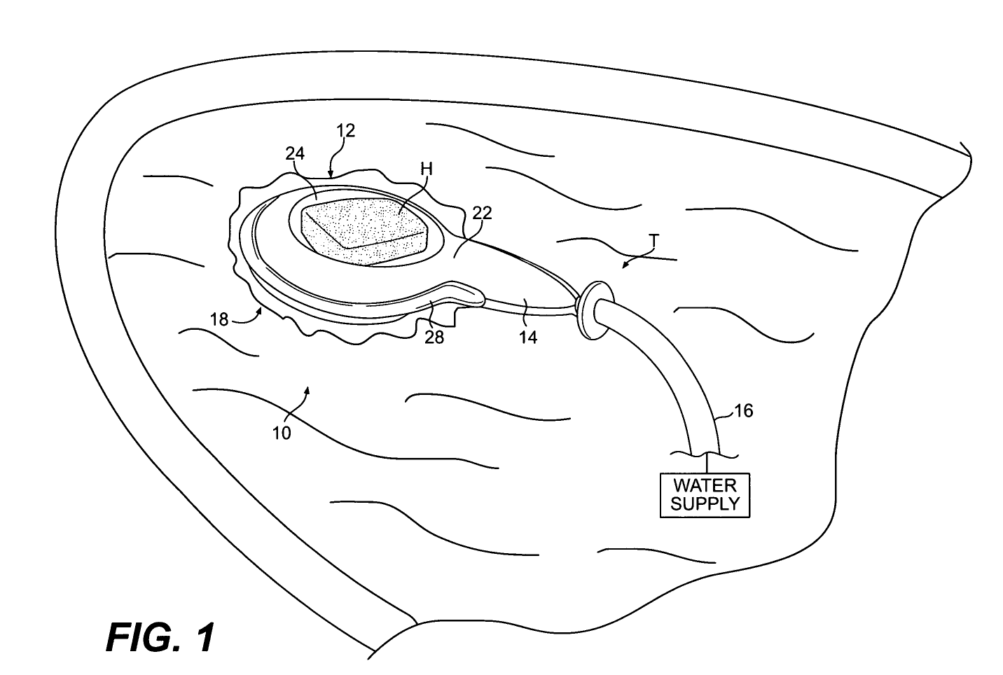

FIG. 1 illustrates a general perspective view of a handheld sprayer system 10. The system 10 includes a spray head 12 having a handle 14 which connects to a flexible water supply conduit 16 as generally understood. The spray head 12 includes a spray nozzle side 18 having a spray nozzle 20 opposite a sprayer backside 22. It should be understood that although a particular shower sprayer arrangement is disclosed in the illustrated embodiment, other arrangements such as sink mounted sprayers will also benefit from the instant invention.

The sprayer backside 22 preferably includes a recessed area 24 to receive hygiene tools H such as a sponge, soap or the like. The recessed area 24 may be generic or specific to a particular tool T. One specific recessed area 24 includes a molded razor receipt area 26 which permits storage and retention of a razor R (FIG. 3).

The spray head 12 preferably includes a buoyancy volume 28 (illustrated schematically) which permits the handheld shower sprayer system 10 to float. The buoyancy volume 28 may be contained within the spray head 12 or located therearound in, for example, a decorative trim. By providing flotation to the sprayer system 10, use and convenience is increased. In other words, the handheld sprayer system 10 need only be dropped into a tub T or the bottom of a shower where the sprayer system 10 is readily retrievable.

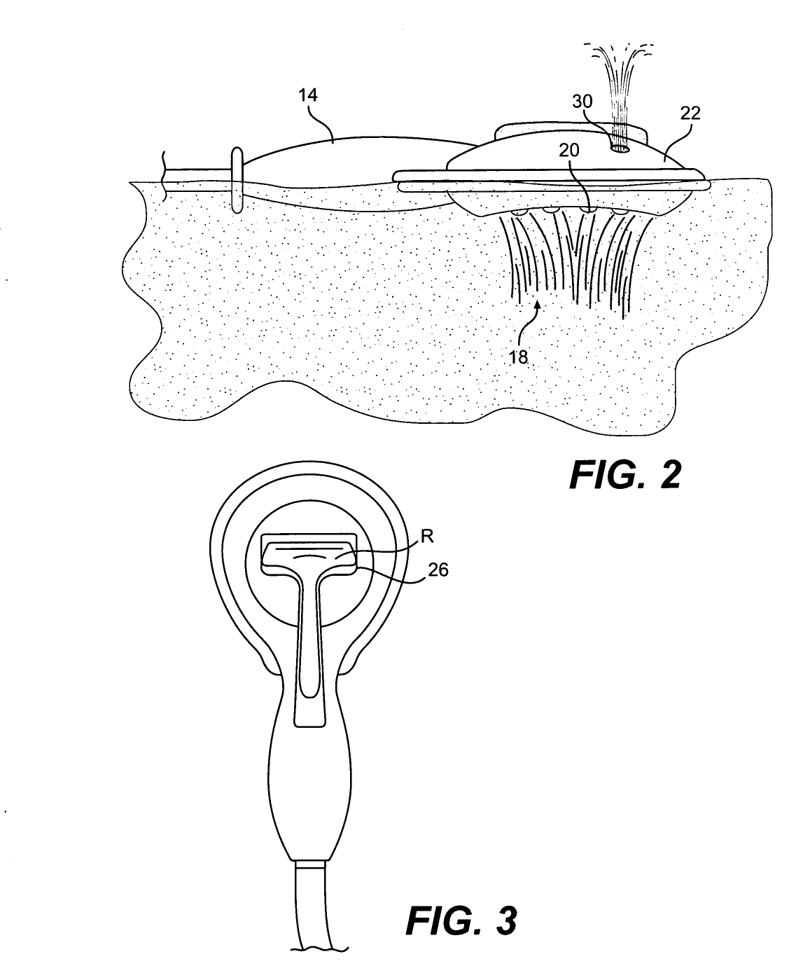

Furthermore, in a tub environment, operation of the spray nozzle 20 permits a water jet effect. That is, the spray head 12 randomly floats around in the tub agitating the otherwise still water (FIG. 2). Operation of the spray nozzle 20 may augment floatation of the handheld sprayer system 10. That is, the buoyancy volume 28 is not sufficient to float the showerhead 12 without the spray nozzle 20 spraying a jet of water. Alternatively, the spray nozzle 20 may be set to automatically shut off when the sprayer system 10 is floating.

Referring to FIG. 2, a fountain nozzle 30 may alternatively be located in the sprayer backside 22. The fountain nozzle 30 provides a spray or fountain of water for entertainment and display when the spray head 12 is floating within the tub. The fountain nozzle 30 provides advantages when bathing a child for both entertainment of the child and may then be hand-held to rinse the bathing child with the relatively low pressure fountain spray. The fountain nozzle 30 is preferably selectively actuated separately from the spray nozzle 20 as generally understood.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A handheld shower sprayer system comprising:
a handheld shower sprayer having a buoyant volume such that said handheld shower sprayer floats.

2. The handheld shower sprayer system as recited in claim 1, wherein said buoyant volume is contained within said handheld shower sprayer.

3. The handheld shower sprayer system as recited in claim 1, further comprising a recessed area opposite a spray nozzle side.

4. The handheld shower sprayer system as recited in claim 1, further comprising a receipt area opposite a nozzle side.

5. The handheld shower sprayer system as recited in claim 1, further comprising a razor receipt area opposite a spray nozzle side.

6. The handheld shower sprayer system as recited in claim 1, wherein said handheld shower sprayer floats when a sprayer nozzle is activated.

7. The handheld shower sprayer system as recited in claim 1, further comprising a fountain nozzle opposite a spray nozzle side.

8. A method of locating a handheld shower sprayer comprising the steps of:
(1) floating a handheld shower sprayer within a body of water.

9. A method as recited in claim 8, wherein said step (1) further comprises:
storing a hygiene tool within the handheld shower sprayer.

10. A method as recited in claim 8, wherein said step (1) further comprises:
storing a razor within the handheld shower sprayer.

11. A method as recited in claim 8, wherein said step (1) further comprises:
(a) spraying a jet of water from the handheld shower sprayer; and
(b) floating the handheld shower sprayer in response to said step (a).

12. A method as recited in claim 8, further comprising the step of:
shutting of a spray nozzle in response to the handheld shower sprayer floating in the body of water.

13. A method as recited in claim 8, wherein said step (1) further comprises:
(a) spraying a fountain of water from the handheld shower sprayer opposite a spray nozzle side.
